(19) United States
(12) Patent Application Publication
(10) Pub. No.: US 2010/0159718 A1
(43) Pub. Date: Jun. 24, 2010

(54) Coaxial Connector

(75) Inventors: Patrick Duquerroy, Seligenstadt (DE); Lieven Decrock, Roeselare (BE)

Correspondence Address: BARLEY SNYDER, LLC, 1000 WESTLAKES DRIVE, SUITE 275, BERWYN, PA, 19312, US

(73) Assignees: TYCO ELECTRONICS AMP GMBH, Bensheim (DE); TYCO ELECTRONICS BELGIUM EC. N.V., Oostkamp (BE)

(21) Appl. No.: 11/993,674

(22) PCT Filed: Jun. 21, 2006
(86) PCT No.: PCT/EP2006/005974

§ 371 Date: Dec. 21, 2007

(30) Foreign Application Priority Data
Jul. 20, 2005 (DE) 10 2005 033 915.8

(51) Int. Cl. H01R 12/00

(52) U.S. Cl. 439/66

(57) ABSTRACT

A coaxial connector for connecting a first printed circuit board to a second printed circuit board is disclosed. The coaxial connector has an inner conductor, an outer conductor, and a dielectric at least partially disposed between the inner conductor and the outer conductor. Each of the inner conductor, the outer conductor, and the dielectric is compressible.

### CROSS-REFERENCE TO RELATED APPLICATION DATA

This application claims the benefit of the earlier filed parent international application number PCT/EP2006/005974 having an international filing date of Jun. 21, 2006 that claims the benefit of DE 10 2005 033 915.8 having a filing date of Jul. 20, 2005.

### FIELD OF THE INVENTION

The present invention relates to a coaxial connector.

### BACKGROUND

Portable electronic devices such as mobile telephones are subject to increasing demands with respect to miniaturization requirements. At present, portable electronic devices offer an increasing functionality with an increasingly small design. The miniaturization of portable electronic devices results in the design of electronic components becoming smaller and the space on the printed circuit board occupied by these electronic components being utilized more efficiently. Thus, it is crucial to design printed circuit boards so that the electronic components take up as little space as possible, but also to keep the distance between printed circuit boards provided with electronic components as short as possible.

In mobile telephones, high frequency signals are transmitted between printed circuit boards that are provided with electronic components. The transmission of such high frequency signals is usually accomplished using a coaxial high frequency connector. A coaxial connector of this type produces the connection between two printed circuit boards and, for this reason, is sometimes also called a “board-to-board connector”. The function of a connector of this type is to transmit high frequency electric signals between two printed circuit boards with as little interference as possible. Such a coaxial connector that connects together two printed circuit boards ideally has good electrical characteristics at high frequencies while also having a small design in order to allow the configuration of increasingly small portable electronic devices.

### SUMMARY

The present invention relates to, in one embodiment, a coaxial connector for connecting a first printed circuit board to a second printed circuit board. The coaxial connector has an inner conductor, an outer conductor, and a dielectric at least partially disposed between the inner conductor and the outer conductor. Each of the inner conductor, the outer conductor, and the dielectric is compressible.

### BRIEF DESCRIPTION OF THE DRAWINGS

The invention will now be described in more detail in the following with reference to the embodiments illustrated in the accompanying drawings. Similar or corresponding details of the coaxial connector according to the invention are provided with the same reference numerals in the figures, in which:

FIG. 1 is an orthogonal cross-sectional view taken through cutting lines A-A of FIG. 3 of a coaxial connector according to the present invention;

FIG. 2 is an oblique cross-sectional view of the coaxial connector of FIG. 1; and

FIG. 3 is an oblique view of a resilient block of the coaxial connector of FIG. 1.

### DETAILED DESCRIPTION OF THE EMBODIMENT(S)

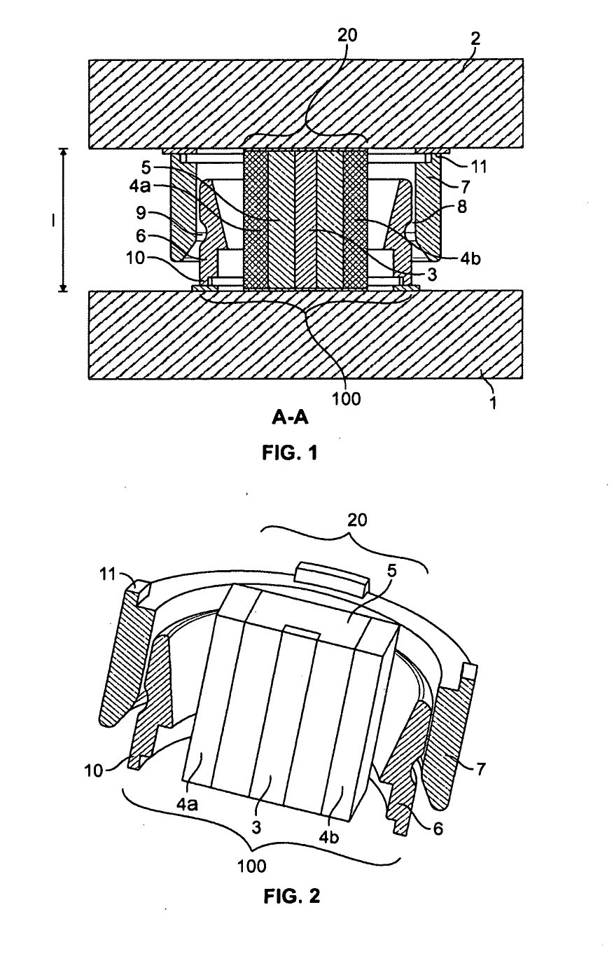

Referring to FIGS. 1-3, the coaxial connector 100 according to the invention for connecting a first printed circuit board 1 to a second printed circuit board 2 comprises a one-piece resilient block 20. The block 20 preferably comprises an elastomer. Two electrically conductive plates, a first plate 4a and a second plate 4b are positioned on two lateral surfaces of the block 20. The first and second plates 4a, 4b preferably comprise an electrically conductive elastomer so that they are compressible and are electrically conductive. When the block 20 is in an assembled position within the coaxial connector 100, the plates 4a, 4b electrically connect the first printed circuit board 1 to the second printed circuit board 2. The first and second plates 4a, 4b serve as a compressible outer conductor of the coaxial connector 100 of the invention

A dielectric 5 that comprises a resilient material such as an elastomer, is provided between the first and second plates 4a, 4b. The dielectric 5 comprises an insulating elastomer, unlike the first and second conductive plates 4a, 4b which comprise an electrically conductive elastomer. An inner conductor 3 that comprises an electrically conductive elastomer penetrates the dielectric 5 from a lateral surface of the block 20 to an opposite lateral surface of the block 20. A longitudinal axis of the inner conductor 3 extends substantially parallel to a plane of the first and second plates 4a, 4b.

The coaxial connector 100 also comprises a hollow conductor 6 that may be soldered onto the first printed circuit board 1. The hollow conductor 6 is substantially annular and has a conical inner surface. Provided on the lower side of the hollow conductor 6 facing the first printed circuit board 1 are inner soldering feet 10 that may be soldered onto the first printed circuit board 1. However, other configurations of the connection between the hollow conductor 6 and the first printed circuit board 1 are also possible. In particular, the hollow conductor 6 may alternatively comprise positioning feet that are adapted to be introduced into corresponding openings in the first printed circuit board 1 before they are soldered.

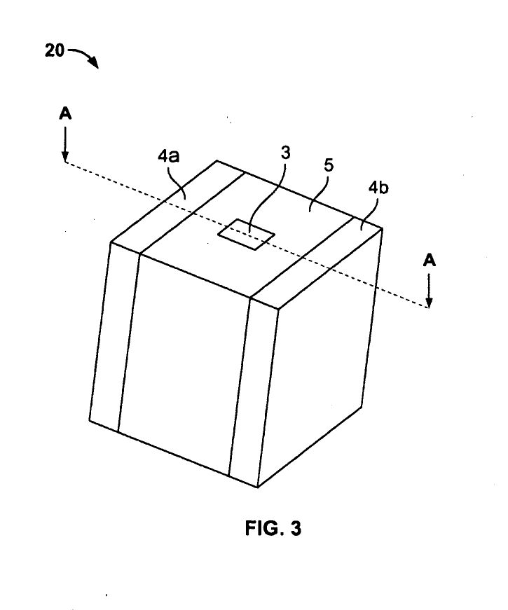

Although the hollow conductor 6, shown in FIGS. 1 and 2, is illustrated as being annular, other configurations are possible, for example, a cuboidal configuration may be used in an alternative embodiment of the coaxial connector. Moreover, the hollow conductor 6 may alternatively be provided without soldering feet and may be soldered directly onto the first printed circuit board 1.

The block 20 is substantially provided in the form of a cuboidal resilient block which may be introduced into the hollow conductor 6. The block 20 is positioned in the hollow conductor 6 so that when the coaxial connector 100 is assembled, the inner conductor 1 electrically connects the first printed circuit board 1 to the second printed circuit board 2.

Although block 20 is described as being made of elastomer, for example silicone, it is possible for block 20 to be made of or comprise different resilient materials, such as springs or the like, provided that these materials provide a resilient block, allowing for a compressible coaxial connector.

Moreover, the resilient block 20 may alternatively be produced not only in the form of a substantially cuboidal block, but instead, in the form of a cylinder or a ball. If the block is configured to be spherical, an outer layer that is insulated from the inner conductor is provided and is positioned on two opposite lateral surfaces of the spherical block or around the complete circumference of the spherical block.

If the block 20 is configured to be cuboidal, it is possible for not only two electrically conductive plates to be positioned on two lateral surfaces of the block, but also, for example, for four electrically conductive plates to be provided on four successive lateral surfaces of the block. Where four conductive plates are provided, the block has around the complete periphery thereof, an electrically conductive outer layer that is insulated from the inner conductor.

The hollow conductor 6 of the coaxial connector 100 according to the invention has a latching recess 8 that extends around the complete periphery of the hollow conductor 6. The latching recess 8 may be locked with a latching projection 9 that is positioned on a sleeve 7 that is mounted on the second printed circuit board 2. The sleeve 7 is provided in the form of a hollow conductor with outer soldering feet 11 that are soldered onto the second printed circuit board 2. The sleeve 7 of the second printed circuit board 2 serves as a positioning aid to precisely connect the second printed circuit board 2 to the first printed circuit board 1.

Although the latching recess 8 in the hollow conductor 6 is described as extending around the complete periphery of the hollow conductor 6, it is possible for the latching recess to extend around only a portion of the complete periphery or to be positioned at a specific point about the periphery of the hollow conductor. Alternatively, a plurality of latching recesses may also be provided in the hollow conductor which may locked with a corresponding plurality of latching projections of the sleeve assembled on the second printed circuit board.

The sleeve 7 provided on the second printed circuit board 2 may be locked with the hollow conductor 6 of the coaxial connector 100 according to the invention. The sleeve 7 serves as a positioning aid and is not necessary for producing the mechanical and electrical connection between the first and second printed circuit boards 1, 2.

The latching recess 8 in the hollow conductor 6 may be locked with a latching projection of an external cable plug (not shown). The latching recess 8 serves as a securing element for an external coaxial test connector that is connected to a measuring device and is connected to the coaxial connector according to the invention for test purposes.

The assembly of a coaxial connector 100 according to the invention onto the first printed circuit board 1 and the connecting together of the first printed circuit board 1 and the second printed circuit board 2 will now be described in more detail in the following.

First, the block 20 is introduced into the hollow conductor 6. In so doing, the conical inner surface of the hollow conductor 6 assists the introduction of the block 20 into the hollow conductor 6. By pressing the resilient block 20 in, the outer surface of the block 20 is deformed at one end of the conical inner surface of the hollow conductor 6, so that the outer surface of the block 20 conforms to the shape of the inner surface of the hollow conductor 6. FIGS. 1-3 do not show this deformation of the outer surface of the block 20.

Once the block 20 has been introduced into the hollow conductor 6, the hollow conductor 6 of the coaxial connector 100 is assembled onto the first printed circuit board 1. The inner soldering feet 10 of the hollow conductor 6 are soldered onto the first printed circuit board 1. A second printed circuit board 2 that is provided with a sleeve 7 is then pressed onto the upper surface, projecting out of the hollow conductor 6, of the block 20. In this way, the block 20 is pressed even further into the hollow conductor 6 until the inner conductor 3 and the first and second plates 4a, 4b connect the first circuit board 1 to the second circuit board 2. The mechanical and electrical connection between the first and second printed circuit boards 1, 2 is thus produced. During this step, the sleeve 7 provided on the second printed circuit board 2 assists in precisely connecting the second printed circuit board 2 to the first printed circuit board 1.

The coaxial connector according to the present invention makes it possible to electrically connect two printed circuit boards of an electronic device where the two printed circuit boards are at a very small spacing from one another. The coaxial connector makes this possible since the inner conductor, outer conductor, and dielectric of the coaxial connector according to the invention are configured to be compressible. Moreover, a portable electronic device in which two printed circuit boards are interconnected by the coaxial connector 100 according to the invention not only gain the advantage that it is of a particularly space-saving design, but that it is also particularly shock-resistant due to this flexible connection between the two printed circuit boards, resulting in a robust, shake-resistant, and disturbance-free connection. Moreover, this connection also has a particularly good thermal expansibility. The integral form of the block 20 simplifies production of the coaxial connector, since the number of constructive elements of the coaxial connector 100 is reduced.

1-18. (canceled)

19. A coaxial connector for connecting a first printed circuit board to a second printed circuit board, the coaxial connector comprising:
an inner conductor;
an outer conductor; and
a dielectric at least partially disposed between the inner conductor and the outer conductor;
wherein each of the inner conductor, the outer conductor, and the dielectric is compressible.

20. A coaxial connector according to claim 19, wherein each of the inner conductor, the outer conductor, and the dielectric comprise a resilient material.

21. A coaxial connector according to claim 19, wherein the inner conductor and the outer conductor comprise an electrically conductive elastomer while the dielectric comprises an insulating elastomer.

22. A coaxial connector according to claim 19, wherein the inner conductor, the outer conductor, and the dielectric are configured as a one-piece resilient block.

23. A coaxial connector according to claim 22, wherein the outer conductor is electrically insulated from the inner conductor.

24. A coaxial connector according to claim 22, wherein the one-piece resilient block is substantially cuboidal.

25. A coaxial connector according to claim 22, wherein the one-piece resilient block comprises at least two electrically conductive plates, each positioned different lateral surfaces of the one-piece resilient block.

26. A coaxial connector according to claim 25, wherein the at least two electrically conductive plates are positioned substantially parallel to each other.

27. A coaxial connector according to claim 25, wherein the at least two electrically conductive plates connect the first printed circuit board to the second printed circuit board.

28. A coaxial connector according to claim 25, wherein the dielectric is disposed between the at least two electrically conductive plates.

29. A coaxial connector according to claim 19, wherein the inner conductor penetrates the dielectric to connect the first printed circuit board to the second printed circuit board.

30. A coaxial connector according to claim 22, further comprising:
a hollow conductor that surrounds the one-piece resilient block and electrically connected to the one-piece resilient block.

31. A coaxial connector according to claim 30, wherein the hollow conductor is soldered to the first printed circuit board.

32. A coaxial connector according to claim 30, wherein the hollow conductor comprises a conical inner surface for accepting the one-piece resilient block.

33. A coaxial connector according to claim 30, wherein the hollow conductor is connected to a sleeve that is connected to the second printed circuit board.

34. A coaxial connector according to claim 33, wherein the hollow conductor comprises at least one latching recess lockable with at least one latching projection of the sleeve.

35. A coaxial connector according to claim 30, wherein the hollow conductor is configured for connection to a cable plug.

36. A coaxial connector according to claim 35, wherein the hollow conductor comprises at least one latching recess that is lockable with at least one latching projection of the cable plug.
